(19) United States
(12) Patent Application Publication
(10) Pub. No.: US 2015/0256079 A1
(43) Pub. Date: Sep. 10, 2015

(54) ELECTRIC POWER SUPPLY CONTROL DEVICE WHICH CAN LOWER POWER CONSUMPTION

(71) Applicant: Konica Minolta, Inc., Tokyo (JP)

(72) Inventors: Taku KIMURA, Toyokawa-shi (JP); Mikiyuki AOKI, Toyohashi-shi (JP); Hideki NAKAMURA, Tokyo-to (JP); Masahiro NONOYAMA, Toyokawa-shi (JP); Junichi MASUDA, Toyokawa-shi (JP); Yohei YAMADA, Tokyo-to (JP)

(73) Assignee: Konica Minolta, Inc., Tokyo (JP)

(21) Appl. No.: 14/643,398

(22) Filed: Mar. 10, 2015

(30) Foreign Application Priority Data
Mar. 10, 2014 (JP) 2014-046503

(51) Int. Cl. H02J 1/00; G03G 15/00

(52) U.S. Cl. CPC H02M 3/24; G03G 15/80

(57) ABSTRACT

An electric power supply control device comprises AC/DC converter, DC/DC converters, and an output electrical voltage monitor unit of the AC/DC converter. When output electrical voltage of the AC/DC converter increases to the first preset value P1, the AC/DC converter stops the convert. When the output electrical voltage decreases to the second preset value P2, the AC/DC converter restarts the convert. The first preset value P1 is equal to or less than the lowest value, out of the upper limit values in electrical voltage ranges in which the DC/DC converters CV1 and CV2 can work. The second preset value P2 is more than or equal to the highest value, out of the lower limit values in electrical voltage ranges in which the DC/DC converters CV1 and CV2 can work.

This application is based on Japanese Patent Application No. 2014-46503 filed with the Japan Patent Office on Mar. 10, 2014, the entire content of which is hereby incorporated by reference.

### BACKGROUND OF THE INVENTION

1. Field of the Invention

This invention relates to an electric power supply control device. More specifically, this invention relates to an electric power supply control device which can lower power consumption.

2. Description of the Related Art

Image forming apparatuses using electrophotographic technology includes a MFP (Multi Function Peripheral) which has a scanner function, a facsimile function, a copying function, a function as a printer, a data transmitting function and a server function, a facsimile device, a copying machine, a printer, or the like.

Electronic devices, for example image forming apparatuses, may convert alternating electrical current into direct electrical current. After that, electronic devices convert the direct electric current input into direct electric current which has a different electrical voltage value by using a DC/DC (direct electric current/direct electric current) converter, and output it to each of loads. Electronic devices may move from a normal mode in which normal process is performed, to an electrical power saving mode in which the power consumption is low. In case that an electronic device is in an energy saving mode, the electronic device provides electric power for only some loads via a low voltage electric power supply.

Recently, awareness of the energy saving grows in the world. In EU (European Union), ErP (Energy-related Products) protocol is enforced. It is a regulation which requires that designing should be environmentally friendly to improve energy saving. Environment codes and standards become all the more severe in the International Energy Star Program which is an environment labeling system in Japan, for energy saving of OA (Office Automation) equipments.

To improve energy saving, it is important to lower power consumption in an electrical power saving mode of an electronic device. More specifically, the ErP protocol requires that power consumption should be equal to or less than 0.5 W in an electrical power saving mode (an OFF mode or a standby mode) of an image forming apparatus or the like.

Documents 1 and 2 below disclose a technique to improve energy saving of electronic devices, for example. Document 1 below, for example, discloses an electronic device which comprises a low voltage electric power supply, an electrical current measuring unit, a DC/DC (direct electric current/direct electric current) converter, a plurality of devices, and an energy saving CPU (Central Processing Unit). The low voltage electric power supply outputs electrical voltage and electrical current. The electrical current measuring unit measures an electrical current value output from the low voltage electric power supply. The DC/DC (direct electric current/direct electric current) converter outputs converted electrical current, in which electrical voltage input from the low voltage electric power supply is converted to electrical voltage which has a different electrical voltage value. The plurality of devices work with electrical voltage and electrical current output from the DC/DC converter. The energy saving CPU can be set in an energy saving mode in which power consumption is reduced. In case the mode is set, the energy saving CPU controls the DC/DC converter to output electrical voltage which has an electrical voltage value corresponding to the minimum electrical current value being measured by the electrical current measuring unit, wherein the electrical voltage value is between a maximum value and a minimum value. The maximum value is the maximum value out of lower limit electrical voltage values in the working electrical voltage ranges of the devices being operated in the energy saving mode. The minimum value is the minimum value out of upper limit electrical voltage values in the working electrical voltage ranges of the devices being operated in the energy saving mode.

Document 2 below discloses a technique of monitoring electrical voltage at a component where a low voltage electric power supply is connected with a DC/DC converter. By reducing outputting electrical voltage of the low voltage electric power supply, the DC/DC converter improves efficiency.

[Document 1] Japan Patent Publication No. 2013-99013 [Document 2] Japanese Translation of PCT International Application Publication No. 2012-505631

### SUMMARY OF THE INVENTION

According to the conventional technique, electronic devices should perform switching operation at all times (including an energy saving mode) at a low voltage electric power supply, so that the low voltage electric power supply keeps outputting constant electrical voltage. In consequence, the switching loss per unit time and power consumption increase.

This invention is achieved to solve the above problem. The object is to provide an electric power supply control device which can lower power consumption.

According to one aspect of this invention, an electric power supply control device comprises a first converter to perform a convert in which direct electric current having a constant electrical voltage value is output by converting input electrical current, and a second converter which is at least one direct electric current/direct electric current converter being connected to an outputting terminal of the first converter, wherein the first converter includes an electrical voltage indicate unit which indicates electrical voltage output to the second converter, the first converter stops the convert in case that output electrical voltage indicated by the electrical voltage indicate unit increased to a first preset value, during the convert, the first converter starts the convert in case that output electrical voltage indicated by the electrical voltage indicate unit decreased to a second preset value which is smaller than the first preset value, during stopping of the convert, the first preset value is equal to or less than the lowest value, out of upper limit values of electrical voltage ranges in which the second converter can work, and the second preset value is more than or equal to the highest value, out of lower limit values of electrical voltage ranges in which the second converter can work.

### BRIEF DESCRIPTION OF THE DRAWINGS

FIG. 1 schematically shows a block diagram of a structure of an image forming apparatus, according to the first embodiment of this invention.

FIG. 2 shows a time chart of transition of output electrical voltage of AC/DC converter 1, according to the first embodiment of this invention.

FIG. 3 shows a time chart of transition of output electrical voltage of AC/DC converter 1, according to the second embodiment of this invention.

FIG. 4 shows an enlarged figure of a portion R in FIG. 3.

FIG. 5 schematically shows a block diagram of a structure of an image forming apparatus, according to the third embodiment of this invention.

FIG. 6 shows a time chart of transition of output electrical voltage of AC/DC converter 1, when a behavior mode signal SN4 input indicates a mode other than the electrical power saving mode.

FIG. 7 shows tables of examples of output electrical voltage at each of DC/DC converters CV1 and CV2, and load electrical current in each of electrical power saving modes, according to the fourth embodiment of this invention.

FIG. 8 schematically shows efficiency of DC/DC converter CV1 in each of electrical power saving modes, with respect to output electrical voltage of AC/DC converter 1, according to the fourth embodiment of this invention.

FIG. 9 schematically shows efficiency of DC/DC converter CV2 in each of electrical power saving modes, with respect to output electrical voltage of AC/DC converter 1, according to the fourth embodiment of this invention.

FIG. 10 schematically shows total efficiency of DC/DC converters CV1 and CV2 in each of electrical power saving modes, with respect to output electrical voltage of AC/DC converter 1, according to the fourth embodiment of this invention.

FIG. 11 schematically shows the first preset value P1 and the second preset value P2 when the behavior mode of the image forming apparatus is electrical power saving mode M1, according to the fourth embodiment of this invention.

FIG. 12 schematically shows the first preset value P1 and the second preset value P2 when the behavior mode of the image forming apparatus is electrical power saving mode M2, according to the fourth embodiment of this invention.

FIG. 13 schematically shows the first preset value P1 and the second preset value P2 when the behavior mode of the image forming apparatus is electrical power saving mode M3, according to the fourth embodiment of this invention.

FIG. 14 shows a table of examples of the range of each of the first preset value P1 and the second preset value P2, according to the fifth embodiment of this invention.

FIG. 15 schematically shows a block diagram of a structure of an image forming apparatus, according to the sixth embodiment of this invention.

### DESCRIPTION OF THE PREFERRED EMBODIMENTS

The embodiments of this invention will be explained based on the figures in the following description.

In the following embodiments, an electric power supply control device is installed on an image forming apparatus. The image forming apparatus may be a MFP, a facsimile device, a copying machine, a printer, or the like. The electric power supply control device may be installed on electronic devices other than image forming apparatuses.

### The First Embodiment

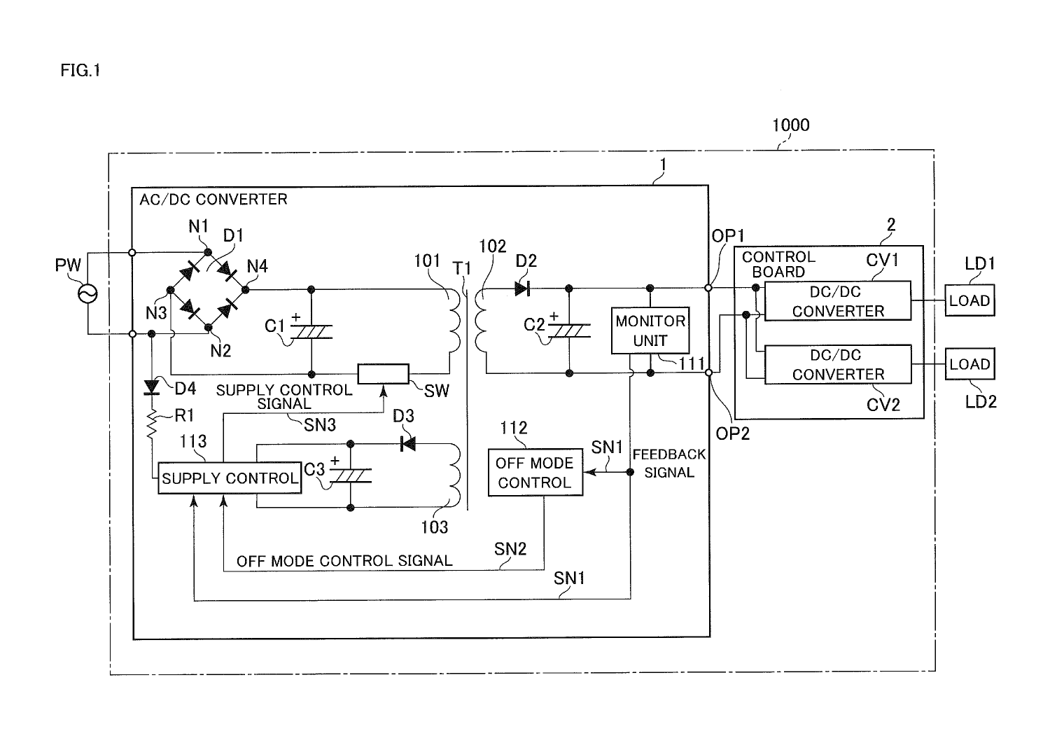

FIG. 1 schematically shows a block diagram of a structure of an image forming apparatus, according to the first embodiment of this invention.

Referring to FIG. 1, an image forming apparatus is mainly equipped with an electric power supply control device 1000 and loads LD1 and LD2. The output side of electric power supply control device 1000 is connected with each of loads LD1 and LD2. Electric power supply control device 1000 converts alternating electrical current (an example of input electrical current) to direct electric current. The alternating electrical current is output from an alternating current electric power supply PW which is a commercial electric power supply. Electric power supply control device 1000 outputs the converted direct electric current to each of loads LD1 and LD2.

Electric power supply control device 1000 includes AC/DC (alternating current/direct electric current) converter 1 (an example of the first converter) and control circuit board 2. AC/DC converter 1 converts alternating electrical current output from alternating current electric power supply PW, and shows behavior to output direct electric current which has a constant electrical voltage value (which is constant electrical voltage) to outputting terminals OP1 and OP2 (hereinafter, the behavior is referred to as a convert). Control circuit board 2 includes DC/DC converters CV1 and CV2 (examples of the second converter). DC/DC converters CV1 and CV2 are installed on control circuit board 2, and step down converters, for example. AC/DC converter 1 is an electric power supply for providing electric power to control circuit board 2. DC/DC converters CV1 and CV2 are parallely connected with each other, and are connected with outputting terminals OP1 and OP2. Outputting terminal of each of DC/DC converters CV1 and CV2 is connected with each of loads LD1 and LD2. The number of DC/DC converters connected with outputting terminals OP1 and OP2 and the number of loads connected with outputting terminals of DC/DC converters are arbitrary.

AC/DC converter 1 includes rectification diodes D1, D2, D3, and D4, smoothing condensers C1, C2, and C3, a transformer T1, a resistor (a start up resistor) R1, a switch SW, an output electrical voltage monitor unit 111 (an example of an electrical voltage indicate unit), an off mode control unit 112, and an electric power supply control unit 113. Off mode control unit 112 and electric power supply control unit 113 are examples of control unit.

Rectification diode D1 is a bridge diode, and includes terminals N1, N2, N3, and N4. Terminal N1 of rectification diode D1 is connected with an L line of alternating current electric power supply PW. Terminal N2 of rectification diode D1 is connected with a N line of alternating current electric power supply PW. Terminal N3 of rectification diode D1 is connected with a negative terminal of smoothing condenser (a primary smoothing condenser) C1. Terminal N4 of rectification diode D1 is connected with a plus terminal of smoothing condenser C1. Herewith, full waves of alternating electrical current output from alternating current electric power supply PW are rectified by rectification diode D1. After this full wave rectification, electrical current is smoothed by smoothing condenser C1. Terminal N2 of rectification diode D1 is connected with electric power supply control unit 113 via rectification diode D4 and resistor R1. Herewith, when the image forming apparatus starts up, electric power is provided by alternating current electric power supply PW, as electric power for starting up of electric power supply control unit 113.

Transformer T1 includes a primary winding 101, a secondary winding 102, and a subsidiary winding 103. Primary winding 101 is parallely connected with smoothing condenser C1. One end of primary winding 101 is connected with the plus terminal of smoothing condenser C1 and terminal N4. The other end of primary winding 101 is connected with the negative terminal of smoothing condenser C1 and terminal N3 via switch SW. Providing electrical current to primary winding 101 or not is selected by Switch SW. Secondary winding 102 is parallely connected with smoothing condenser C2. One end of secondary winding 102 is connected with a plus terminal of smoothing condenser (a secondary smoothing condenser) C2 and outputting terminal OP1 via rectification diode D2. The other end of secondary winding 102 is connected with a negative terminal of smoothing condenser C2 and outputting terminal OP2. Subsidiary winding 103 is parallely connected with smoothing condenser C3. One end of subsidiary winding 103 is connected with a plus terminal of smoothing condenser C3 and electric power supply control unit 113 via rectification diode D3. The other end of subsidiary winding 103 is connected with a negative terminal of smoothing condenser C3 and electric power supply control unit 113. By switching operation of switch SW, pulsed input electrical current flows in primary winding 101. Then, electrical current by the convert flows in each of secondary winding 102 and subsidiary winding 103. In consequence, electric power supply control unit 113 is provided with electric power.

Output electrical voltage monitor unit 111 is connected between outputting terminal OP1 and outputting terminal OP2. Output electrical voltage monitor unit 111 outputs feedback signal SN1 to each of off mode control unit 112 and electric power supply control unit 113. Feedback signal SN1 indicates electrical voltage between outputting terminal OP1 and outputting terminal OP2 (hereinafter, the electrical voltage may be referred to as output electrical voltage of AC/DC converter 1). The electrical voltage is electrical voltage which AC/DC converter 1 outputs, to each of DC/DC converters CV1 and CV2.

Off mode control unit 112 and electric power supply control unit 113 controls starting and stopping of the convert of AC/DC converter 1, based on feedback signal SN1 input from output electrical voltage monitor unit 111. Electric power supply control unit 113 performs on/off switching behavior of switch SW, to make output electrical voltage indicated by feedback signal SN1 constant electrical voltage, when converting. Off mode control unit 112 outputs an off mode control signal SN2 to electric power supply control unit 113, based on feedback signal SN1 input from output electrical voltage monitor unit 111. The off mode control signal is for stopping the on/off switching behavior of switch SW. Off mode control signal SN2 may be a signal which starts on/off switching behavior of switch SW.

More specifically, when off mode control signal SN2 from off mode control unit 112 is enabled (input), electric power supply control unit 113 stops the convert. Hence, output electrical voltage of AC/DC converter I decreases from the constant electrical voltage value. When off mode control signal SN2 from off mode control unit 112 is disabled (not input), electric power supply control unit 113 starts the convert. Hence, output electrical voltage of AC/DC converter 1 increases to the constant electrical voltage value.

Next, behavior of electric power supply control device 1000 of this embodiment will be explained.

Alternating electrical current from alternating current electric power supply PW is provided for electric power supply control unit 113, via rectification diode D4 and resistor R1. The alternating electrical current becomes start up electric power (start up electric power supply) which starts up electric power supply control unit 113. Alternating electrical current from alternating current electric power supply PW is full-wave-rectified by rectification diode D1, and smoothed by smoothing condenser C1. Herewith, direct electric current having ripples is generated. Electric power supply control unit 113 provided with start up electric power supply begins to control switching of transformer T1. Electric power supply control unit 113 controls on/off of switch SW, changes the electrical current to high frequency pulsed electrical current, and supplies it to primary winding 101. In consequence, transformed alternating electrical current occurs at each of secondary winding 102 and subsidiary winding 103.

Alternating electrical current occurs at subsidiary winding 103 is full-wave-rectified by rectification diode D3, smoothed by smoothing condenser C3, and provided to electric power supply control unit 113. The electrical current becomes power supply electrical current (power supply electrical voltage) to drive electric power supply control unit 113 after starting up.

Alternating electrical current which occurred at secondary winding 102 is rectified by rectification diode D2, smoothed by smoothing condenser C2, and becomes direct electric current which has a constant electrical voltage value. The electrical current is output to outputting terminals OP1 and OP2, as output electrical voltage of AC/DC converter 1.

Output electrical voltage monitor unit 111 monitors output electrical voltage of AC/DC converter 1, and outputs feedback signal SN1 to each of off mode control unit 112 and electric power supply control unit 113. The feedback signal SN1 indicates output electrical voltage of AC/DC converter 1. Electric power supply control unit 113 performs on/off switching behavior of switch SW by transmitting electric power supply control signal SN3 to switch SW. Electric power supply control unit 113 controls electrical current which flows in primary winding 101 by PWM (Pulse Width Modulation), to make output electrical voltage of AC/DC converter 1 indicated by feedback signal SN1 input constant. Hence, AC/DC converter 1 performs the convert.

When AC/DC converter 1 exhibits the convert, in case that output electrical voltage of AC/DC converter 1 indicated by feedback signal SN1 increased to the first preset value P1, off mode control unit 112 enables off mode control signal SN2. When off mode control signal SN2 is enabled, electric power supply control unit 113 stops on/off switching behavior of switch SW, and turns off switch SW at all times. Herewith, AC/DC converter 1 stops the convert. The first preset value P1 is set beforehand as a value being equal to or less than the lowest value, out of the upper limit values in electrical voltage ranges where each of DC/DC converters CV1 and CV2 can work (as a value being equal to or less than the minimum value of maximum allowable electrical voltage values of each of DC/DC converters CV1 and CV2). Preferably, the first preset value P1 is equal to the value of constant electrical voltage which is output by AC/DC converter 1 when converting.

When the convert is stopping, output electrical voltage of AC/DC converter 1 does not rapidly decrease. The output electrical voltage decreases little by little, by the effect of smoothing condenser C2. Off mode control unit 112 disables off mode control signal SN2, in case that AC/DC converter 1 stops the convert and output electrical voltage of AC/DC converter 1 indicated by feedback signal SN1 decreased to the second preset value P2. When off mode control signal SN2 is disabled, electric power supply control unit 113 begins to perform on/off switching behavior of switch SW. Herewith, AC/DC converter 1 starts (restarts) the convert. The second preset value P2 is set beforehand as a value being equal to or more than the highest value, out of the lower limit values in electrical voltage ranges where each of DC/DC converters CV1 and CV2 can work (as a value being equal to or more than the maximum value of minimum working electrical voltage values of each of DC/DC converters CV1 and CV2).

For example, it is assumed that electrical voltage range in which DC/DC converter CV1 can work is 3.1V to 5.2V, and electrical voltage range in which DC/DC converter CV2 can work is 3.0V to 5.1V. In this instance, the first preset value P1 is set as a value being equal to or less than 5.1V, and the second preset value P2 is set as a value being more than or equal to 3.1 V.

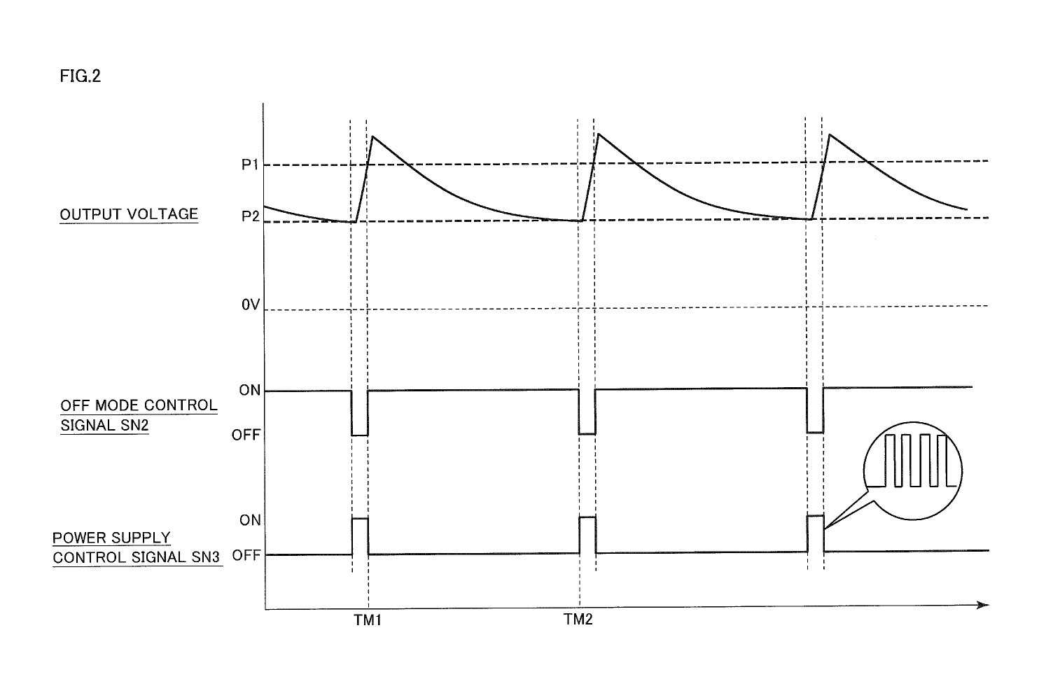

FIG. 2 shows a time chart of transition of output electrical voltage of AC/DC converter 1, according to the first embodiment of this invention. In FIG. 2, electric power supply control signal SN3 enlarged in the convert is shown.

Referring to FIG. 2, when output electrical voltage of AC/DC converter 1 indicated by feedback signal SN1 reaches the first preset value P1 at clock time TM1, off mode control signal SN2 is enabled, and the convert (PWM control) of electric power supply control unit 113 stops. Herewith, output electrical voltage of AC/DC converter 1 begins to decrease. Time is required from when off mode control signal SN2 is enabled at clock time TM1 to when electric power supply control unit 113 stops the convert and the output of electric power supply control signal SN3 is disabled. In the meantime, output electrical voltage of AC/DC converter 1 continues to increase. Hence, output electrical voltage of AC/DC converter 1 reaches a maximum peak, shortly after clock time TM1. The maximum peak is slightly higher than the first preset value P1.

When output electrical voltage of AC/DC converter 1 indicated by feedback signal SN1 reaches the second preset value P2 at clock time TM2 (>clock time TM1), off mode control signal is disabled, and the convert of electric power supply control unit 113 (PWM control) restarts. Herewith, output electrical voltage of AC/DC converter 1 begins to increase. In the convert, output electrical voltage of AC/DC converter 1 is controlled so that output electrical voltage of AC/DC converter 1 becomes the first preset value P1. Time is required from when off mode control signal SN2 is disabled at clock time TM2 to when electric power supply control unit 113 starts the convert and the output of electric power supply control signal SN3 is enabled. In the meantime, output electrical voltage of AC/DC converter 1 continues to decrease. Hence, output electrical voltage of AC/DC converter 1 reaches a minimum value, shortly after clock time TM2. The minimum peak is slightly lower than the second preset value P2.

After that, electric power supply control unit 113 repeats stop and restart of the convert, in accordance with input off mode control signal SN2.

According to this embodiment, from when output electrical voltage of AC/DC converter 1 indicated by feedback signal SN1 increased to the first preset value P1 to when output electrical voltage of AC/DC converter 1 decreases to the second preset value P2, the convert of AC/DC converter 1 (on/off switching behavior of switch SW of electric power supply control unit 113) stops. Then, the number of times of switching per unit time can decrease, and switching loss can be reduced. In consequence, power consumption can be lowered.

### The Second Embodiment

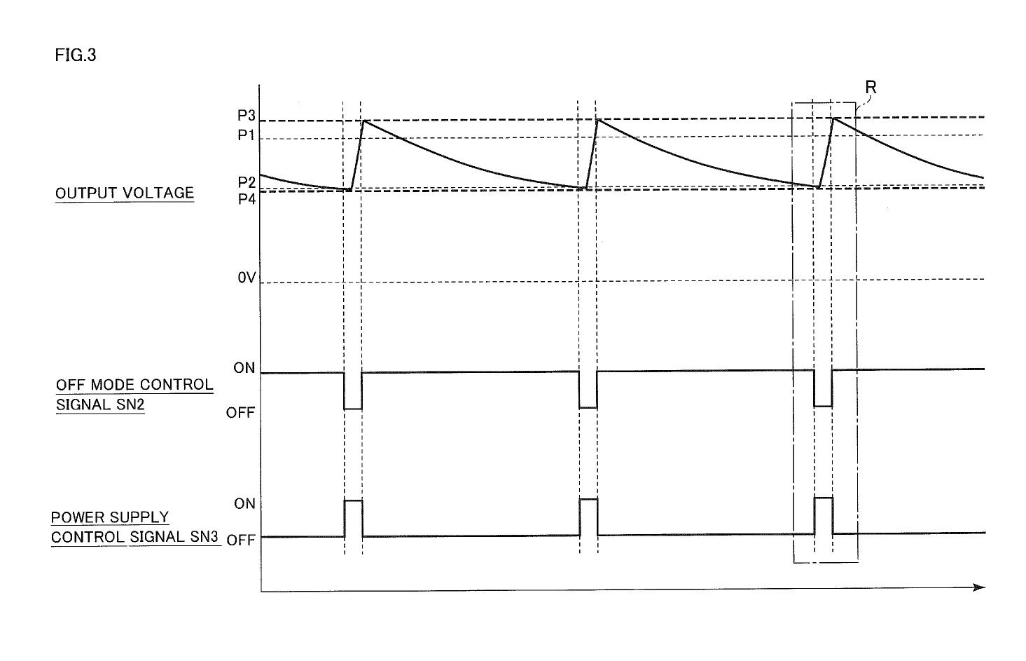

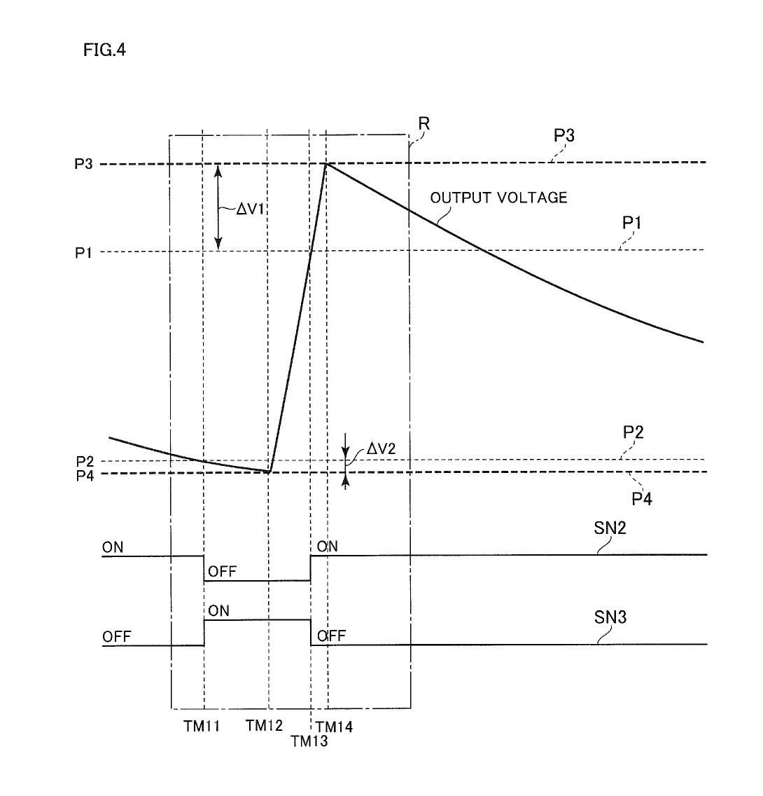

FIG. 3 shows a time chart of transition of output electrical voltage of AC/DC converter 1, according to the second embodiment of this invention. FIG. 4 shows an enlarged figure of a portion R in FIG. 3.

Referring to FIGS. 3 and 4, in this embodiment, output electrical voltage of AC/DC converter 1 is controlled, so that output electrical voltage of AC/DC converter 1 does not exceed the third preset value P3, and does not underrun the fourth preset value P4.

More specifically, at clock time TM11 (in FIG. 4) when the convert of electric power supply control unit 113 stops, output electrical voltage of AC/DC converter 1 indicated by feedback signal SN1 reaches the second preset value P2, and off mode control signal SN2 is disabled, electric power supply control unit 113 starts the convert at clock time TM12, and the output of electric power supply control signal SN3 is enabled. Clock time TM12 is time after a lapse of a predetermined time from clock time TM11. From clock time TM11 to clock time TM12, output electrical voltage of AC/DC converter 1 continues to decrease. Hence, output electrical voltage of AC/DC converter 1 becomes the fourth preset value P4 which is a minimum value, at clock time TM12.

The second preset value P2 is set, so that the fourth preset value P4 is equal to or less than the highest value, out of the lower limit values in electrical voltage ranges where each of DC/DC converters CV1 and CV2 can work. The second preset value P2 is set, considering an amount of change (an amount of descent) delta V2 (in FIG. 4) of output electrical voltage of AC/DC converter 1 from clock time TM11 to clock time TM12.

When exhibiting the convert of electric power supply control unit 113 at clock time TM13, in case output electrical voltage of AC/DC converter 1 indicated by feedback signal SN1 reaches the first preset value P1, and off mode control signal SN2 is enabled, electric power supply control unit 113 stops the convert at clock time TM14, and the output of electric power supply control signal SN3 is disabled. Clock time TM14 is after a lapse of a predetermined time from clock time TM13. From clock time TM13 to clock time TM14, output electrical voltage of AC/DC converter 1 continues to increase. Hence, output electrical voltage of AC/DC converter 1 becomes the third preset value P3 which is a maximum value at clock time TM14.

The first preset value P1 is set, so that the third preset value P3 is equal to or less than the lowest value, out of the upper limits of electrical voltage ranges where each of DC/DC converters CV1 and CV2 can work. The first preset value P1 is set, considering an amount of change (an amount of increase) delta V1 (in FIG. 4) of output electrical voltage of AC/DC converter 1 from clock time TM13 to clock time TM14.

A structure of the image forming apparatus, and behavior of electric power supply control device 1000 other than the above explanation are similar to the first embodiment. The same numerals are provided for same components, and the explanation is not repeated.

According to this embodiment, output electrical voltage of AC/DC converter 1 is controlled, so that output electrical voltage of AC/DC converter 1 does not exceed the third preset value P3 and does not underrun the fourth preset value P4. Hence, DC/DC converters CV1 and CV2 can be more safely controlled.

### The Third Embodiment

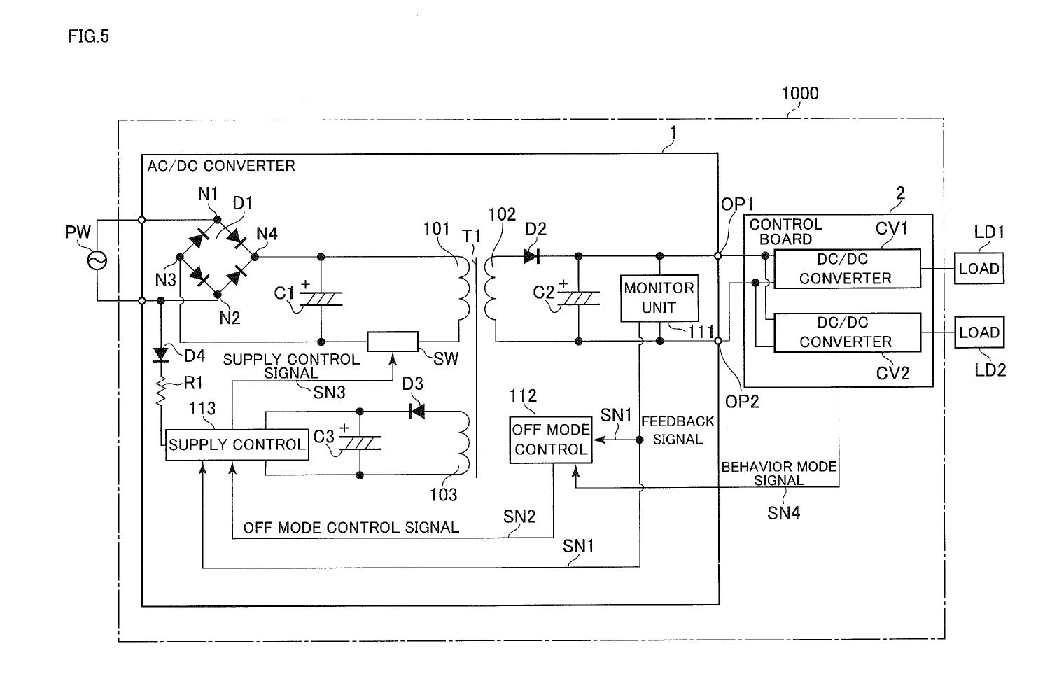

FIG. 5 schematically shows a block diagram of a structure of an image forming apparatus, according to the third embodiment of this invention.

Referring to FIG. 5, according to this embodiment, electric power supply control device 1000 changes the electric power providing state (the behavior mode of the image forming apparatus) for each of loads LD1 and LD2, depending on an electrical power saving mode, a printing mode, a waiting mode, or the like. The electrical power saving mode is a behavior mode in which power consumption is low when compared to the printing mode and the waiting mode. The printing mode and the waiting mode are examples of constant electrical voltage modes. Control circuit board 2 is connected with off mode control unit 112. Control circuit board 2 outputs a behavior mode signal SN4 to off mode control unit 112. Behavior mode signal SN4 indicates information which relates to behavior modes of a printing mode, a waiting mode, an electrical power saving mode, or the like of the image forming apparatus.

In case that behavior mode signal SN4 input indicates information of an electrical power saving mode, off mode control unit 112 turns off mode control signal SN2 on or off by the method shown in FIG. 2, in similar way to the first embodiment. More specifically, when the behavior mode of the image forming apparatus is an electrical power saving mode, in case that AC/DC converter 1 is executing the convert, and output electrical voltage indicated by output electrical voltage monitor unit 111 increased to the first preset value P1, AC/DC converter 1 stops the convert. When the behavior mode of the image forming apparatus is the electrical power saving mode, in case that AC/DC converter 1 does not perform the convert, and output electrical voltage indicated by output electrical voltage monitor unit 111 decreased to the second preset value P2, AC/DC converter 1 begins to perform the convert.

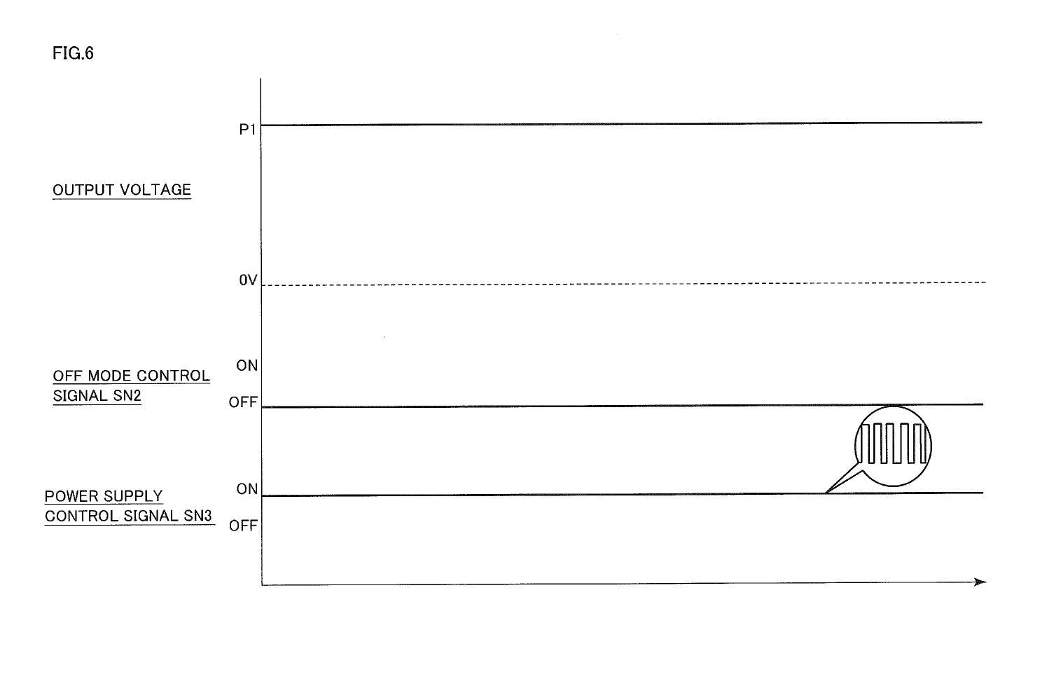

FIG. 6 shows a time chart of transition of output electrical voltage of AC/DC converter 1, when a behavior mode signal SN4 input indicates a mode other than the electrical power saving mode. In FIG. 6, electric power supply control signal SN3 during the convert is shown enlarged.

Referring to FIG. 6, in case that behavior mode signal SN4 input is a mode other than the electrical power saving mode (a printing mode, a waiting mode, or the like), off mode control unit 112 keeps off mode control signal SN2 off. Herewith, AC/DC converter 1 keeps the convert, and output electrical voltage of AC/DC converter 1 is maintained as the first preset value P1, which is a constant electrical voltage value (a constant voltage value) being set beforehand.

A structure of the image forming apparatus, and behavior of electric power supply control device 1000 other than the above explanation are similar to the first embodiment. The same numerals are provided for same components, and the explanation is not repeated.

According to this embodiment, in case that the behavior mode of the image forming apparatus is an electrical power saving mode, switching loss can be reduced and power consumption can lower. In case that the behavior mode of the image forming apparatus is a mode other than the electrical power saving mode, constant electrical voltage output can be provided for control circuit board 2, etc.

### The Fourth Embodiment

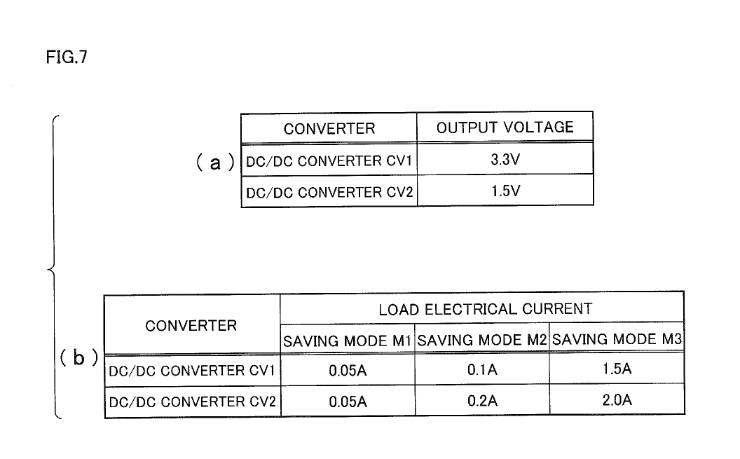

FIG. 7 shows tables of examples of output electrical voltage at each of DC/DC converters CV1 and CV2, and load electrical current in each of electrical power saving modes, according to the fourth embodiment of this invention.

Referring to FIG. 7 (a), an image forming apparatus can perform three electrical power saving modes which are electrical power saving modes M1. M2 and M3. Each of DC/DC converters CV1 and CV2 outputs electric power (constant electrical voltage) which have constant electrical voltage value to each of loads LD1 and LD2, regardless of the behavior mode of the image forming apparatus. The output electrical voltage of DC/DC converter CV1 is 3.3V. The output electrical voltage of DC/DC converter CV2 is 1.5V.

Referring to FIG. 7 (b), each of DC/DC converters CV1 and CV2 provides different magnitude of electrical current (load electrical current) in response to the behavior mode which is the electrical power saving mode M1, M2 or M3 of the image forming apparatus, to each of loads LD1 and LD2. More specifically, when the behavior mode of the image forming apparatus is electrical power saving mode M1, load electrical current of DC/DC converter CV1 is 0.05 A, and load electrical current of DC/DC converter CV2 is 0.05 A. When the behavior mode of the image forming apparatus is electrical power saving mode M2, load electrical current of DC/DC converter CV1 is 0.1 A, and load electrical current of DC/DC converter CV2 is 0.2 A. When the behavior mode of the image forming apparatus is electrical power saving mode M3, load electrical current of DC/DC converter CV1 is 1.5 A, and load electrical current of DC/DC converter CV2 is 2.0 A. As for power consumption of electrical power saving modes, power consumption in electrical power saving mode M3 is the largest, power consumption in electrical power saving mode M2 is the second largest, and power consumption in electrical power saving mode M1 is the lowest.

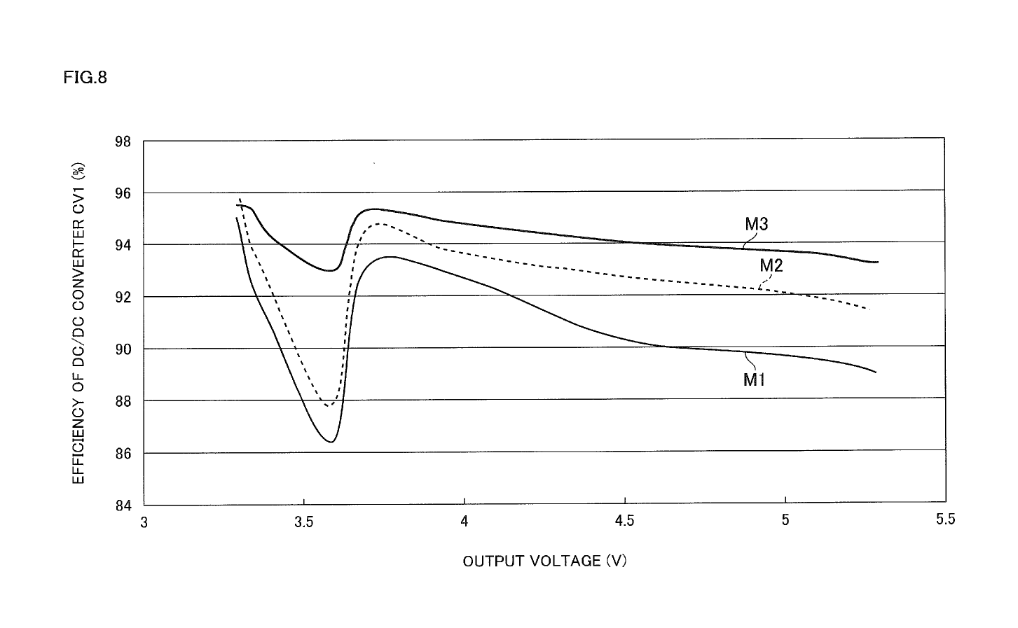

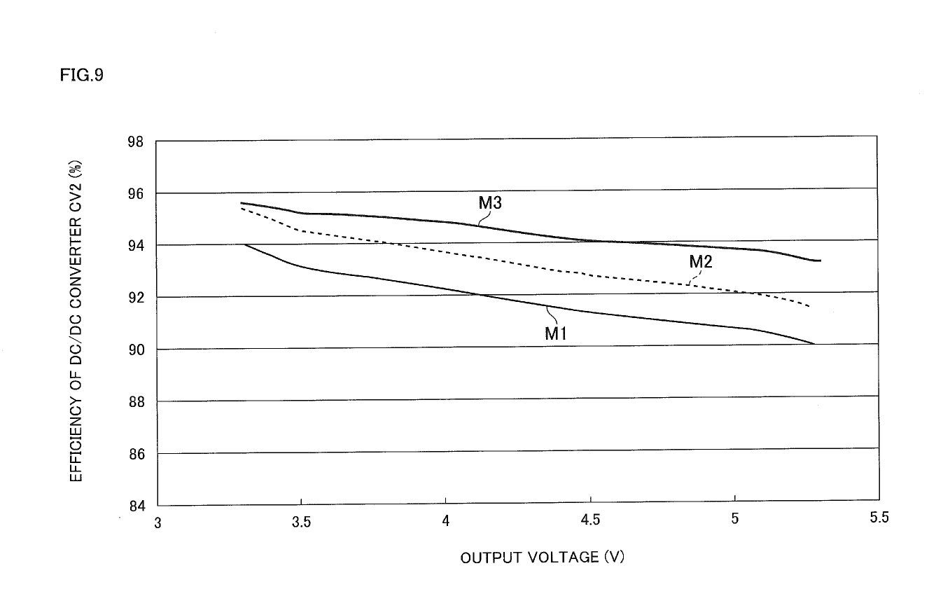

FIG. 8 schematically shows efficiency of DC/DC converter CV1 in each of electrical power saving modes with respect to output electrical voltage of AC/DC converter 1, according to the fourth embodiment of this invention. FIG. 9 schematically shows efficiency of DC/DC converter CV2 in each of electrical power saving modes with respect to output electrical voltage of AC/DC converter 1, according to the fourth embodiment of this invention.

Referring to FIGS. 8 and 9, efficiency (converting efficiency (%)) of each of DC/DC converters CV1 and CV2 varies in response to output electrical voltage of AC/DC converter 1 (input electrical voltage of the DC/DC converter). Efficiency of each of DC/DC converters CV1 and CV2 varies in response to magnitude of load electrical current. The larger consumption electrical current is, efficiency of DC/DC converter CV1 is higher. When output electrical voltage of AC/DC converter 1 is about 3.8V, efficiency of DC/DC converter CV1 is a maximum value.

The larger consumption electrical current is, efficiency of DC/DC converter CV1 is higher. The efficiency of DC/DC converter CV1 is the highest, when the mode is electrical power saving mode M3. Efficiency of DC/DC converter CV1 is a maximum value when output electrical voltage of AC/DC converter 1 is about 3.8V in any of these cases of electrical power saving modes M1, M2, and M3. On the other hand, the larger consumption electrical current is, efficiency of DC/DC converter CV2 is higher (in FIG. 9). The efficiency is the highest in case of electrical power saving mode M3. The higher output electrical voltage of AC/DC converter 1, efficiency of DC/DC converter CV2 is lower, in any of these cases of electrical power saving modes M1, M2, and M3.

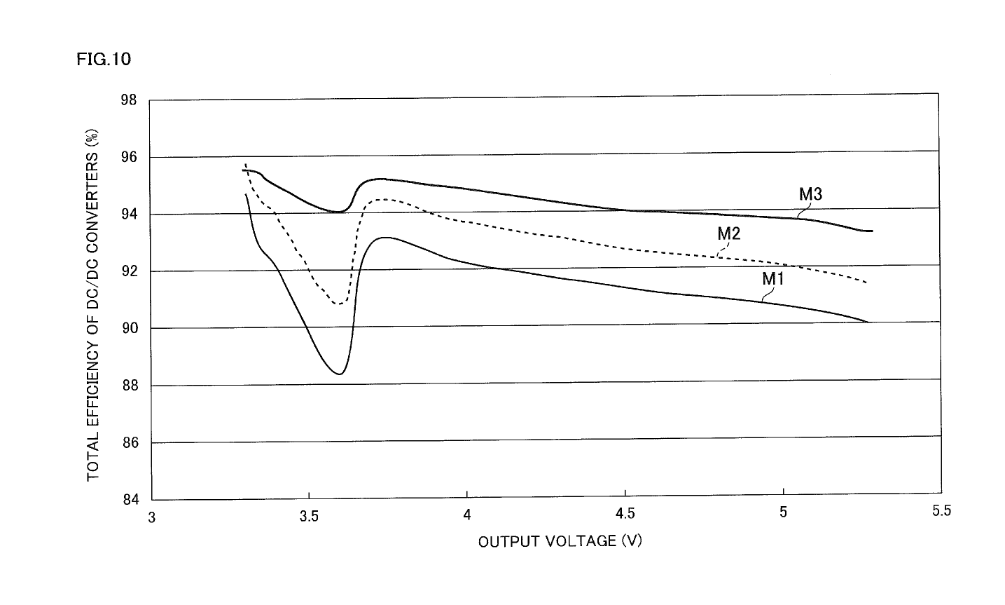

FIG. 10 schematically shows total efficiency of DC/DC converters CV1 and CV2 in each of electrical power saving modes with respect to output electrical voltage of AC/DC converter 1, according to the fourth embodiment of this invention.

Referring to FIG. 10, total efficiency of DC/DC converters CV1 and CV2 is an average of characteristics of efficiency of DC/DC converter CV1 shown in FIG. 8 and characteristics of efficiency of DC/DC converter CV2 shown in FIG. 9. The larger consumption electrical current is, the total efficiency of DC/DC converters CV1 and CV2 is higher. The total efficiency is the highest in case of electrical power saving mode M3. The total efficiency of DC/DC converters CV1 and CV2 is a maximum value, when output electrical voltage of AC/DC converter 1 is about 3.8V, in any of these cases of electrical power saving modes M1, M2, and M3.

In case that there are a plurality of electrical power saving modes, the first preset values P1 in power saving modes M1, M2, and M3 are preferably set at different values from each other. Similarly, the second preset values P2 in electrical power saving modes M1, M2, and M3 are preferably set at different values from each other. The specific setting method of each of the first prescribed values P1 and the second prescribed values P2, in case that there is a plurality of electrical power saving modes, will be explained as follows.

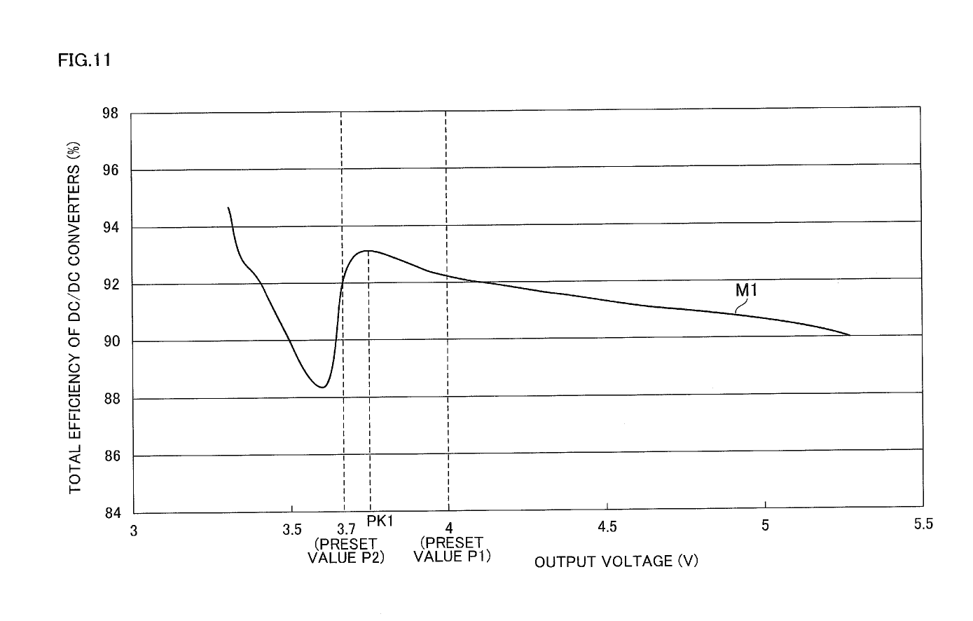

FIG. 11 schematically shows the first preset value P1 and the second preset value P2 when the behavior mode of the image forming apparatus is electrical power saving mode M1, according to the fourth embodiment of this invention.

Referring to FIG. 11, total efficiency of DC/DC converters CV1 and CV2 is a maximum value, when the behavior mode of the image forming apparatus is electrical power saving mode M1 and output electrical voltage of AC/DC converter 1 is electrical voltage value PK1. To work DC/DC converters CV1 and CV2 within a range of high efficiency (for example, more than or equal to 93%), the first preset value P1 is set at 4.0V which is more than or equal to electrical voltage value PK1. The second preset value P2 is set at 3.7V which is equal to or less than electrical voltage value PK1.

By widening the gap between the first preset value P1 and the second preset value P2, a period in which a switching operation of electric power supply control unit 113 is off can be longer. In case that DC/DC converters CV1 and CV2 is step down converters, the second preset value P2 is preferably more than or equal to a maximum of output electrical voltage of DC/DC converters CV1 and CV2 (in this case, the maximum value is 3.3V, referring to the table of FIG. 7 (a)).

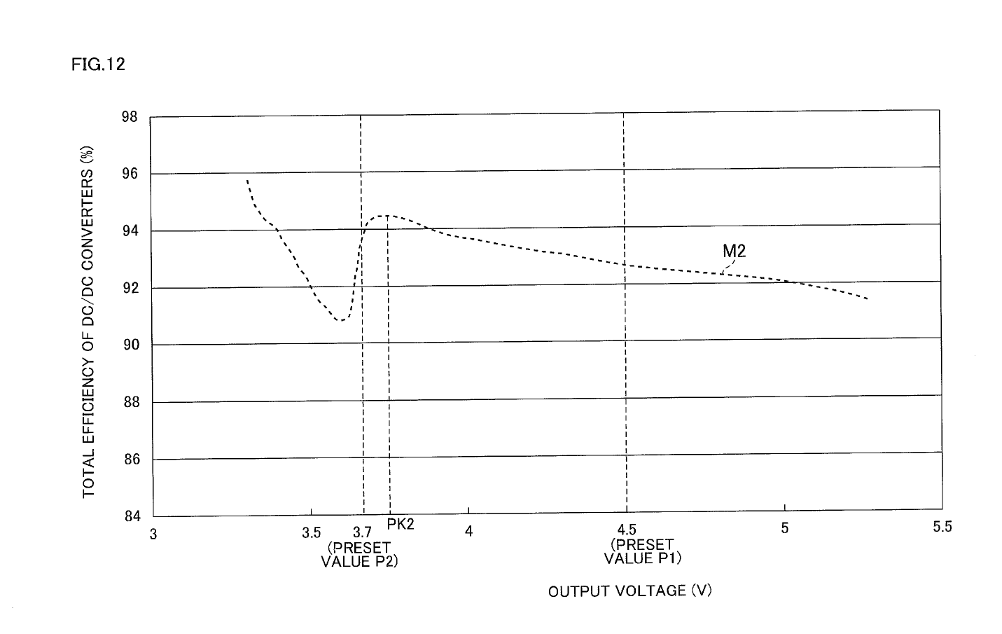

FIG. 12 schematically shows the first preset value P1 and the second preset value P2 when the behavior mode of the image forming apparatus is electrical power saving mode M2, according to the fourth embodiment of this invention.

Referring to FIG. 12, total efficiency of DC/DC converters CV1 and CV2 is a maximum value, when the behavior mode of the image forming apparatus is electrical power saving mode M2 and output electrical voltage of AC/DC converter 1 is electrical voltage value PK2. To work DC/DC converters CV1 and CV2 within a range of high efficiency, the first preset value P1 is set at 4.5V where output electrical voltage is more than or equal to electrical voltage value PK2. The second preset value P2 is set at 3.7V where output electrical voltage is equal to or less than electrical voltage value PK2. The decrease of total efficiency with increase of output electrical voltage of AC/DC converter 1 in case of electrical power saving mode M2 is slow, when compared to the case of electrical power saving mode M1. Hence, the first preset value P1 is set at a high value, when compared to the case of electrical power saving mode M1.

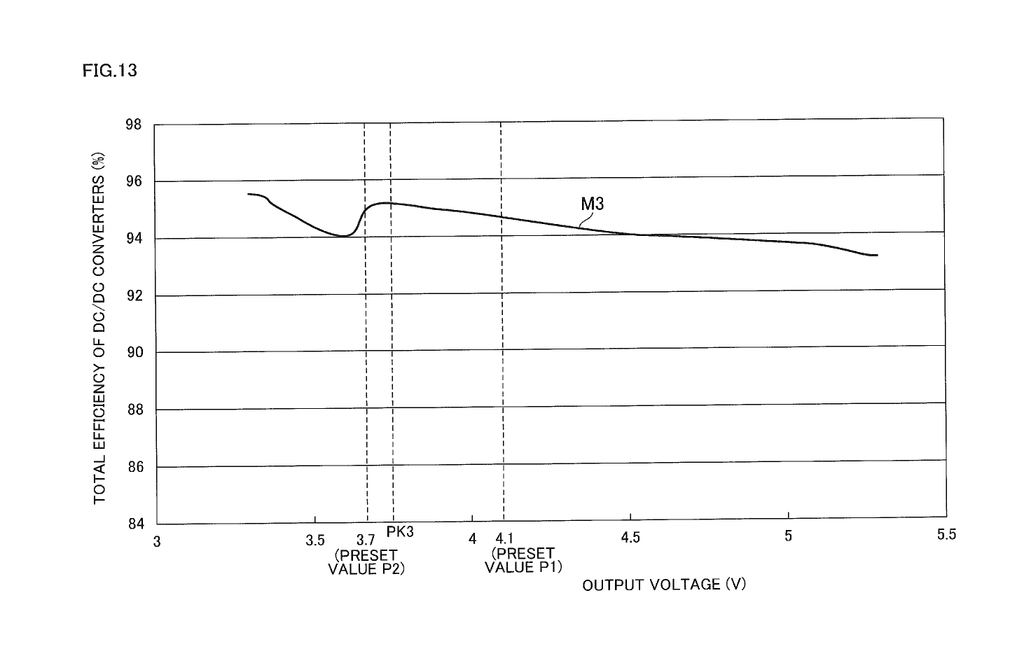

FIG. 13 schematically shows the first preset value P1 and the second preset value P2 when the behavior mode of the image forming apparatus is electrical power saving mode M3, according to the fourth embodiment of this invention.

Referring to FIG. 13, total efficiency of DC/DC converters CV1 and CV2 is a maximum value, when the behavior mode of the image forming apparatus is electrical power saving mode M3 and output electrical voltage of AC/DC converter 1 is electrical voltage value PK3. To work DC/DC converters CV1 and CV2 within a range of high efficiency, the first preset value P1 is set at 4.1V which is more than or equal to electrical voltage value PK3. The second preset value P2 is set at 3.7V which is equal to or less than electrical voltage value PK3.

The structure of the image forming apparatus and behavior of electric power supply control device 1000 other than the above description are similar to the third embodiment. The same numerals are provided for same components and the explanation is not repeated.

According to this embodiment, the first preset value P1 and the second preset value P2 are set at different values in each of electrical power saving modes. Hence, DC/DC converters CV1 and CV2 can be work effectively in each of electrical power saving modes. According to this embodiment, efficiency being more than or equal to 92% in electrical power saving modes M1 and M2, and efficiency being more than or equal to 94% in electrical power saving mode M3 can be achieved, for examples.

### Fifth Embodiment

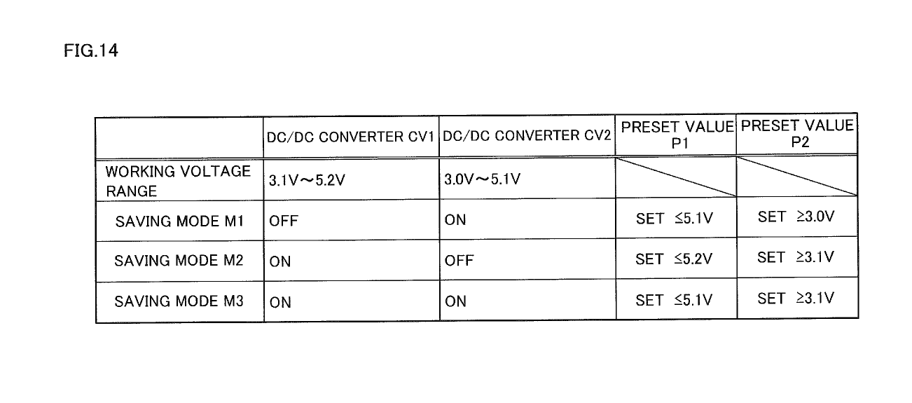

FIG. 14 shows a table of examples of the range of each of the first preset value P1 and the second preset value P2, according to the fifth embodiment of this invention.

Referring to FIG. 14, according to this embodiment, the working DC/DC converter(s) (DC/DC converters being provided with electric power from AC/DC converter 1) is different in each of electrical power saving modes. The first preset value P1 in each of electrical power saving modes is set as a value being equal to or less than the lowest value, out of the upper limit values in electrical voltage ranges where the DC/DC converters which are operated in the electrical power saving mode can work. The second preset value P2 in each of electrical power saving modes is set as a value being equal to or more than the highest value, out of the lower limit values in electrical voltage ranges where the DC/DC converters which are operated in the electrical power saving mode can work.

More specifically, in case that the behavior mode of the image forming apparatus is electrical power saving mode M1, DC/DC converter CV1 is not operated (DC/DC converter CV1 is not provided with electric power), and DC/DC converter CV2 is operated (DC/DC converter CV2 is provided with electric power). In electrical power saving mode M1, the first preset value P1 is set equal to or less than 5.1V which is the upper limit of the electrical voltage range where DC/DC converter CV2 which is operated in electrical power saving mode M1 can work. The second preset value P2 in electrical power saving mode M1 is set more than or equal to 3.0V which is the lower limit of the electrical voltage range where DC/DC converter CV2 which is operated in electrical power saving mode M1 can work.

When the behavior mode of the image forming apparatus is electrical power saving mode M2, DC/DC converter CV1 is operated and DC/DC converter CV2 is not operated. In electrical power saving mode M2, the first preset value P1 is set equal to or less than 5.2V which is the upper limit of the electrical voltage range where DC/DC converter CV1 which is operated in electrical power saving mode M2 can work. The second preset value P2 in electrical power saving mode M2 is set more than or equal to 3.1V which is the lower limit of the electrical voltage range where DC/DC converter CV1 which is operated in electrical power saving mode M2 can work.

In case that the behavior mode of the image forming apparatus is electrical power saving mode M3, both DC/DC converters CV1 and CV2 are operated. In electrical power saving mode M3, the first preset value P1 is set equal to or less than 5.1V which is the lowest limit out of the upper limits of the electrical voltage ranges where DC/DC converters CV1 and CV2 which are operated in electrical power saving mode M3 can work. The second preset value P2 in electrical power saving mode M3 is set more than or equal to 3.1 V which is the highest limit out of the lower limits of the electrical voltage ranges where DC/DC converters CV1 and CV2 which are operated in electrical power saving mode M3 can work.

The structure of the image forming apparatus and behavior of electric power supply control device 1000 other than the above description are similar to the third embodiment. The same numerals are provided for same components and the explanation is not repeated.

According to this embodiment, the first preset value P1 and the second preset value P2 in each of electrical power saving modes are set, based on electrical voltage ranges where DC/DC converters operated in the electrical power saving mode can work. Hence, DC/DC converters can work in proper electrical voltage.

### The Sixth Embodiment

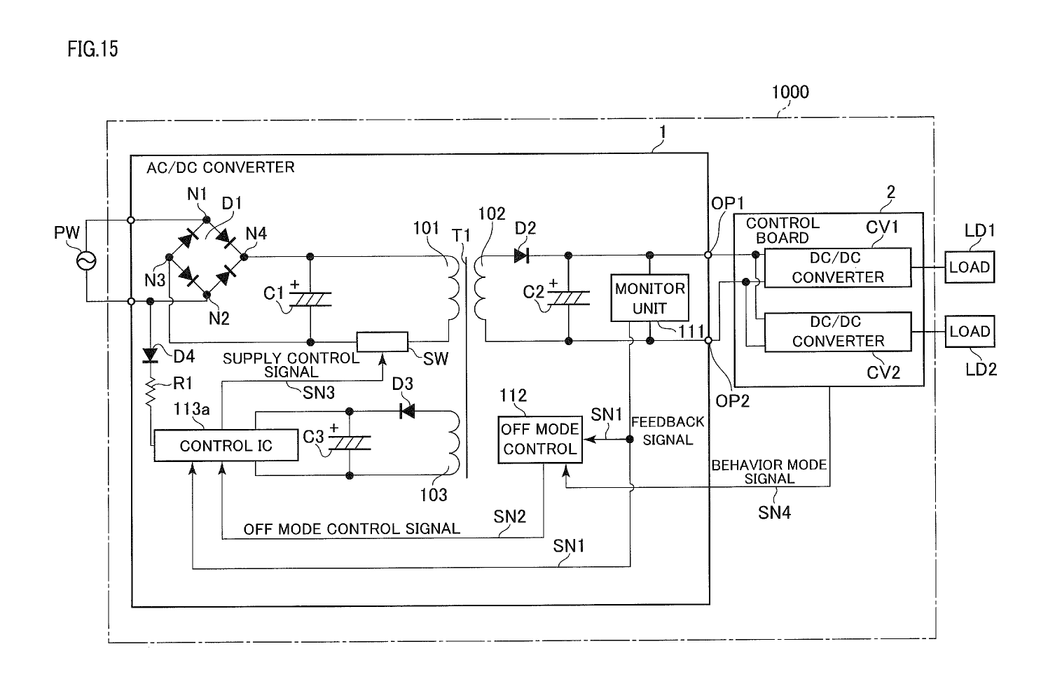

FIG. 15 schematically shows a block diagram of a structure of an image forming apparatus, according to the sixth embodiment of this invention.

Referring to FIG. 15, according to this embodiment, electric power supply control unit includes an electric power supply control IC (Integrated Circuit) 113a. Electric power supply control IC 113a has an off mode function. The off mode function of electric power supply control IC 113a means a mode in which the output of electric power supply control IC 113a (the convert of AC/DC converter 1) stops during electric power supply control IC 113a is being provided with electric power.

In case that off mode control unit 112 enables off mode control signal SN2, electric power supply control IC 113a enters the off mode. In this mode, electric power supply control IC 113a stops outputting electric power supply control signal SN3, and stops switching of switch SW.

The structure of the image forming apparatus and behavior of electric power supply control device 1000 other than the above description are similar to the third embodiment. The same numerals are provided for same components and the explanation is not repeated.

According to this embodiment, electric power supply control IC 113a is provided with electric power regardless of off mode control signal SN2. The time period, from when off mode control signal SN2 is turned off to when electric power supply control unit 113 restarts the convert, can be shortened. [Others]

According to above embodiments, the first converter is an AC/DC converter which receives the input of alternating electrical current. The first converter may be a DC/DC converter which receives the input of direct electric current.

After the third embodiment, the behavior modes of the image forming apparatus include the three electrical power saving modes. The number of electrical power saving modes in an electric power supply control device installed on an electronic device is arbitrary. An electronic device, in which an electric power supply control device is loaded, may have a single behavior mode.

The above embodiments may be combined with each other. For example, electric power supply control IC 113a in the sixth embodiment may apply to the electric power supply control unit of the first embodiment. In the third to sixth embodiments, output electrical voltage of AC/DC converter 1 may be controlled, so that the output electrical voltage does not exceed the third preset value P3 and does not underrun the fourth preset value P4, as the second embodiment.

According to this embodiment, an electric power supply control device which can lower power consumption is provided.

The processes described in the above embodiments can be executed by software or a hardware circuit. A computer program which executes the processes in the above embodiments can be provided. The program may be provided recorded in recording media of CD-ROMs, flexible disks, hard disks, ROMs, RAM, memory cards, or the like to users. The program is executed by a computer of a CPU or the like. The program may be downloaded to a device via communication lines like the interne.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electric power supply control device comprising:
a first converter to perform a convert in which direct electric current having a constant electrical voltage value is output by converting input electrical current, and
a second converter which is at least one direct electric current/direct electric current converter being connected to an outputting terminal of the first converter, wherein
the first converter includes an electrical voltage indicate unit which indicates electrical voltage output to the second converter,
the first converter stops the convert in case that output electrical voltage indicated by the electrical voltage indicate unit increased to a first preset value, during the convert,
the first converter starts the convert in case that output electrical voltage indicated by the electrical voltage indicate unit decreased to a second preset value which is smaller than the first preset value, during stopping of the convert,
the first preset value is equal to or less than the lowest value, out of upper limit values of electrical voltage ranges in which the second converter can work, and
the second preset value is more than or equal to the highest value, out of lower limit values of electrical voltage ranges in which the second converter can work.

2. The electric power supply control device according to claim 1, wherein
the first converter further includes a control unit for controlling a stop and a start of the convert of the first converter, based on output electrical voltage indicated by the electrical voltage indicate unit.

3. The electric power supply control device according to claim 2, wherein
the first converter includes
a primary winding,
a secondary winding being electrically connected with the second converter and generates alternating electrical current by the convert, and
a switch for switching whether electrical current is provided or not, to the primary winding,
the control unit includes
an electric power supply control unit for switching the switch, so that output electrical voltage indicated by the electrical voltage indicate unit is at a constant electrical voltage value,
an off mode control unit for transmitting at least one of a signal to stop the switching of the electric power supply control unit, and a signal to start the switching of the electric power supply control unit, based on output electrical voltage indicated by the electrical voltage indicate unit.

4. The electric power supply control device according to claim 2, wherein
the first preset value is set, so that a third preset value is equal to or less than the lowest value, out of upper limit values in electrical voltage ranges in which the second converter can work, wherein the third preset value is a maximum value of output electrical voltage indicated by the electrical voltage indicate unit when the first converter is performing the convert, and
the second preset value is set, so that a fourth preset value is equal to or more than the highest value, out of lower limit values in electrical voltage ranges in which the second converter can work, wherein the fourth preset value is a minimum value of output electrical voltage indicated by the electrical voltage indicate unit when the first converter stops the convert.

5. The electric power supply control device according to claim 2, wherein
the control unit includes an integrated circuit having an off mode function which is for stopping the convert of the first converter when the integrated circuit is provided with electric power.

6. The electric power supply control device according to claim 1, wherein
the electric power supply control device changes a providing state of electric power to a load which is connected with an outputting terminal of the second converter, between a constant electrical voltage mode and an electrical power saving mode in which power consumption is lower than power consumption of the constant electrical voltage mode,
the first converter stops the convert, in case that (1) the providing state of electric power to the load is the electrical power saving mode, (2) the first converter is performing the convert, and (3) output electrical voltage indicated by the electrical voltage indicate unit increased to the first preset value,
the first converter starts the convert, in case that (1) the providing state of electric power to the load is the electrical power saving mode, (2) the first converter is stopping the convert, and (3) output electrical voltage indicated by the electrical voltage indicate unit decreased to the second preset value, and
the first converter keeps the convert, in case that the electric power supply control device is in the constant electrical voltage mode.

7. The electric power supply control device according to claim 6, wherein.
the electrical power saving mode includes at least a first and a second electrical power saving mode,
the first preset values of the first and the second electrical power saving modes are different from each other, and the second preset values of the first and the second electrical power saving modes are different from each other.

8. The electric power supply control device according to claim 7, wherein
the second converter comprises a plurality of second converters, and the second converters being working in each of the first and the second electrical power saving modes are different from each other,
the first preset value of the first electrical power saving mode is equal to or less than the lowest value, out of the upper limit values of electrical voltage ranges in which the second converters which are operated in the first electrical power saving mode can work,
the second preset value of the first electrical power saving mode is more than or equal to the highest value, out of the lower limit values of electrical voltage ranges in which the second converters which are operated in the first electrical power saving mode can work,
the first preset value of the second electrical power saving mode is equal to or less than the lowest value, out of the upper limit values of electrical voltage ranges in which the second converters which are operated in the second electrical power saving mode can work,
the second preset value of the second electrical power saving mode is more than or equal to the highest value, out of the lower limit values of electrical voltage ranges in which the second converters which are operated in the second electrical power saving mode can work.

9. The electric power supply control device according to claim 1, wherein
the first preset value is equal to an output electrical voltage value of the first converter during the convert.

10. The electric power supply control device according to claim 1, wherein
the first preset value is more than or equal to an output electrical voltage value of the first converter, in case that converting efficiency of the second converter is a maximum,
the second preset value is equal to or less than an output electrical voltage value of the first converter, in case that converting efficiency of the second converter is a maximum.

11. The electric power supply control device according to claim 1, wherein
the second preset value is more than or equal to a maximum value of output electrical voltage of the second converter.

12. The electric power supply control device according to claim 1, wherein
the second converter is installed on a control circuit board of an image forming apparatus,
the first converter is an electric power supply which provides electric power to the control circuit board of the image forming apparatus.

13. An image forming apparatus comprising:
the electric power supply control device according to claim 1.
